(19) United States
(12) Patent Application Publication
(10) Pub. No.: US 2017/0281467 A1
(43) Pub. Date: Oct. 5, 2017

(54) Compact Pill Bottle Cap Requiring Biometric Authentication for Removal

(71) Applicant: Brandon Solotoff, Great Neck, NY (US)

(72) Inventor: Brandon Solotoff, Great Neck, NY (US)

(21) Appl. No.: 15/472,480

(22) Filed: Mar. 29, 2017

Related U.S. Application Data
(60) Provisional application No. 62/314,525, filed on Mar. 29, 2016.
(60) Provisional application No. 62/366,692, filed on Jul. 26, 2016.
(60) Provisional application No. 62/477,553, filed on Mar. 28, 2017.

(51) Int. Cl. A61J 1/14; A61J 7/04; B67B 3/00; A61J 1/03

(52) U.S. Cl. CPC A61J 1/1437; A61J 1/03; A61J 1/1418; A61J 7/0418; A61J 7/0481; B67B 3/00

(57) ABSTRACT

A pill bottle cap provides access to authorized users using a biometric authentication feature. The pill bottle cap broadly includes: a shroud; a plurality of clamp members, each movably mounted to the shroud; a drive member interconnected with each of the clamp members to cause the clamp members to move in a first direction when the drive member is actuated in a first direction, and to cause the clamp members to move in a second direction when the drive member is actuated in a second direction; an actuator configured to actuate the drive member to selectively move in each of the first and second directions; and biometric identification module coupled to the actuator, and configured to activate the actuator to cause the selective movement upon identification of an authorized user. Each of the components are configured and positioned to minimize a height and a volume of the pill bottle cap.

### CROSS REFERENCES TO RELATED APPLICATIONS

This application claims priority on U.S. Provisional Application Ser. No. 62/314,525, filed on Mar. 29, 2016, on U.S. Provisional Application Ser. No. 62/366,692, filed on Jul. 26, 2016, and on U.S. Provisional Application Ser. No. 62/477,553, filed on Mar. 28, 2017, all disclosures of which are incorporated herein by reference.

### FIELD OF THE INVENTION

The present invention relates to pill bottles and the corresponding safety cap used thereon, and more particularly to improvements to a child-proof cap that is also elder-friendly, and accessible using a biometric feature of the patient, a caregiver, or other designated individual.

### BACKGROUND OF THE INVENTION

A cap for a bottle that includes a safety feature intended to prevent access to contents that could be harmful to young children has been known in the art for a substantial period of time. For example, U.S. Pat. No. 1,089,887, issued in 1914 to August A. Wave, discloses a particular bottle and cap “especially designed for use as a container for poisons,” which has threading that, requires “reversed motions” for its removal. U.S. Pat. No. 2,061,214 to Sentman discloses a safety screw cap that may be threaded upon a bottle having conventional threads, and which may be simply removed with downward pressure in opposition to a spring, and with it thereafter being rotated without the use of any tools. U.S. Pat. No. 3,426,932 to Rouse discloses a “Tamper-Proof Poison Bottle Closure” that may be used on the threads of a bottle, with its removal requiring that the authorized person insert and turn the corresponding key in the keyhole. U.S. Pat. No. 3,313,441 was issued in 1967 to Jerome Fadden, and discloses a “Safety Combination Cap” intended for pill bottles, and requires that its plurality of disks be brought into alignment in order to remove the cap to extract the contents of the bottle.

Other types of devices for limiting access to medicines have since been devised. For example, U.S. Patent Application Publication No. 2003/0174554 by Dunstone discloses a container having a specialized “body” and “lid” that requires a “locking ring” to secure the lid to the body, and which may permit access to the specialized body upon biometric authentication of the patient or caregiver.

U.S. Pat. No. 6,382,416 to Gainey discloses a “Medicine Safety Storage System” that includes a particular housing portion, a corresponding cap portion, and a means for releasably locking the cap to the housing. The securing means permits use of a fingerprint to trigger unlocking of the cap portion with respect to the housing portion, to access the conventional “medicine container” (i.e., a pill bottle) that may be stored within the oversized hollow housing.

U.S. Patent Application Publication 2010/0013597 by Determan is for a lock box that may safely store a plurality of pill bottles or other medicine containers therein, and which includes an electromechanical lock that may sense biometric data to permit unlocking of the lock.

The present invention offers a number of improvements over these and other prior art references.

### OBJECTS OF THE INVENTION

It is an object of the invention to provide an improved safety cap for use with a prior art pill bottle, with it being securable thereto to prevent access by young children or other unauthorized persons.

It is another object of the invention to provide an improved safety cap that does not require use of a key, or the memorization of a combination or other code for unlocking of the cap.

It is a further object of the invention to provide an improved safety cap for a prior art pill bottle that may be easily removed by an elderly person who may possess modest hand/finger dexterity and strength.

It is another object of the invention to provide an improved safety cap for a prior art pill bottle that may be unlocked using a biometric feature of the patient or caregiver, such as a fingerprint.

t is also an object of the invention to provide an improved safety cap for a prior art pill bottle that uses an electromechanical lock that may be unlocked using battery power.

It is a further object of the invention to provide an improved safety cap for a prior art pill bottle that uses an electromechanical lock that may be unlocked using solar power.

It is another object of the invention to include circuitry configured to trigger a speaker or other means of emitting sound, to provide an audible alarm when the cap has not been secured back onto the bottle, which may utilize a proximity sensor, or may simply determine if the cap has remained unlocked for a period of time that exceeds a threshold amount of time.

It is a further object of the invention to incorporate a microprocessor and/or other related computer circuitry to enable certain functionality, including Blue Tooth capabilities to permit transmitting of information via a wireless connection to a smart phone app or other smart device, that may include a number of times that the safety cap has been cycled open/closed; a reminder to the patient of the need to renew/refill the prescription, or an automatic message to the pharmacy to anticipate refilling to the prescription; warnings about current medication contained within the bottle; and important doctor-related information.

Further objects and advantages of the invention will become apparent from the following description and claims, and from the accompanying drawings.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An improved safety cap for use with a prior art pill bottle is securable thereto to prevent access by young children or other unauthorized persons. The improved safety cap does not require use of a key, or the memorization of a combination or other code for unlocking of the cap. Instead, the improved safety cap for a prior art pill bottle uses a biometric feature of the patient or caregiver, such as a fingerprint, to unlock the cap and provide access to the medication. The improved safety cap may use an electromechanical lock.

One embodiment of the improved pill bottle cap is shown within FIG. 3A. The prior art pill bottle (see FIG. 1) may include a generic cylindrical container portion that extends upwardly from a bottom end towards a top end. Proximate to the upper end of the pill bottle, an annular protrusion may extend radially outward to form a corresponding annular lip. A plurality of laterally extending hook members may protrude from the annular protrusion and may be used to releasably secure the prior art cap to the pill bottle, using corresponding features within the cap's interior.

FIG. 5 shows a cross-sectional view through the component parts of the first cap embodiment, and through the prior art pill bottle. The component parts that may be used to form the cap, may be particularly configured and positioned/oriented to produce a compact cap with a minimized height and volume. As seen in FIG. 5, the cap of the first embodiment may principally include a bottle cover, two or more clamp members (note that only one clamp member is shown on the right-hand side in FIG. 5), a drive member, an actuator, a battery, a fingerprint reader, and a shroud.

As seen in FIG. 6 and FIG. 7, the bottle cover may rest upon the second end of the pill bottle, and the clamp members, which may be slidably received by the bottle cover, may furthermore be configured for a portion thereof to engage the sides of the annular protrusion, and/or the lip, as discussed hereinafter.

Where an odd number of clamp members are used, they may be positioned to be equally spaced about the pill bottle (i.e., 120 degrees apart for 3 clamp members, or 72 degrees apart for 5 clamp members, etc.). Where an even number of clamp members are used for the cap arrangement, the cap may have pairs of clamp members that engage on opposite sides of the pill bottle, and where more than two pairs are utilized, the clamp pairs may be equally spaced about the axis of the cap. Any number of clamp members could be used.

As seen in FIG. 9, FIG. 10, and FIG. 11, each of the clamp members of this embodiment may be generally C-shaped, and may have an elongated upper leg, a short lower leg, and a leg extending therebetween. The distance between the bottom of the upper leg and the top of the lower leg (based on the orientation depicted within the figures) may be formed to correspond to the extent of the annular protrusion in the axial direction of the prior art pill bottle.

There are at least a couple of options for the length of the short horizontal lower leg. The leg may be sized to be slightly less than, or substantially the same length as, the extent to which the annular protrusion protrudes outwardly from the cylindrical body of the pill bottle. For either of these embodiments, care would need to be taken by the elder user when placing the cap onto the pill bottle, to ensure that the clamp members would be positioned (i.e., would be clocked) to fall between the laterally extending hook members on the annular protrusion, in order to be able to properly engage the annular protrusion and the lip of the pill bottle.

Alternatively, to provide a cap embodiment that may be configured for more universal usage with respect to an assortment of different prior art pill bottles, the length of the leg may be sized to be the slightly larger than the extent to which both the annular protrusion and the laterally extending hook members protrude outwardly from the pill bottle container. In this embodiment care would not be required by the elder user when placing the cap onto the pill bottle. With this embodiment, the clamp members would be able to engage the lip (although it would not be in contact with the side of the annular protrusion), irrespective of the relative positioning (i.e., the clocking) of the clamp members with respect to the laterally extending hook members on the annular protrusion, because the vertical leg of the clamp members would be positioned to be clear of the annular protrusion (compare the clamp member and arrangement shown in FIG. 6A, with the clamp and arrangement shown in FIG. 6).

In any one of these arrangements/embodiments, each of the clamp members may be slidably received by the bottle cover using any suitable sliding arrangement known in the art. FIGS. 9-10, shows each of the clamp members having a slot on each side of the leg that may be slidably received within a corresponding pair of recesses formed in the bottle cover.

The drive member (FIGS. 7-8) may include a cylindrical portion that may extend from a base plate, and which cylindrical portion may be formed to be concentric to a hub that may also protrude from the base plate. For the drive member shown in FIG. 7, the interior surface of the cylinder may have a plurality of gear teeth formed thereon that may be driven by gear teeth on the shaft of a corresponding actuator. Also, the side of the base plate opposite from the interior of the cylindrical portion may have helical threading protruding therefrom. The top of the elongated upper leg of each of the clamp members may also have a plurality of teeth formed thereon (FIG. 9), which are configured to correspond to and be engaged by the helical threading on the drive member.

Therefore, as illustrated in FIG. 6, rotation of the drive member about its axis may cause each of the clamp members to simultaneously translate radially outward from the center of the bottle cover to become disengaged from the annular protrusion and its lip on the pill bottle, and permit removal of the cap therefrom.

After the improved cap has been placed back onto the pill bottle, the drive member may be counter-rotated about its axis, as shown in FIG. 7 (i.e., rotated in an opposite direction as previously done for disengagement), to cause each of the clamp members to simultaneously translate radially inward towards the center of the pill bottle to reengage the annular protrusion and lip on the pill bottle, and prevent unauthorized removal of the cap therefrom.

The rotation and counter-rotation of the drive member may be provided by an actuator, which in one arrangement of this embodiment may be an electrically powered a rotary actuator that may be powered by a battery, or which may be powered by any other suitable power source, (e.g., energy produced from a photocell).

The improved safety cap may include circuitry configured to trigger a speaker or other sound emitting device, to provide an audible alarm when the cap has not been secured back onto the bottle, which may utilize a proximity sensor, or which may simply determine if the cap has remained unlocked for a period of time that exceeds a threshold amount of time.

Another embodiment of the improved cap may incorporate a microprocessor and/or other related circuitry to enable certain functionality, including Blue Tooth capabilities to permit transmitting of information via a wireless connection to a smart phone app or other smart device application, that may include a number of times that the safety cap has been cycled open/closed; a reminder to the patient of the need to renew/refill the prescription, or an automatic message to the pharmacy to anticipate refilling to the prescription; warnings about current medication contained within the bottle; and important doctor-related information.

### BRIEF DESCRIPTION OF THE DRAWINGS

The description of the various example embodiments is explained in conjunction with appended drawings, in which:

FIG. 1 illustrates a front view of a prior art pill bottle that is configured to have a corresponding prior art child-proof cap secured thereon.

FIG. 2 is the front view of FIG. 1, but is shown with the child-proof cap releasably secured onto the pill bottle.

FIG. 3 is a front view of the prior art pill bottle of FIG. 1, but which also shows a cap that requires biometric authentication for access, in accordance with a first embodiment of the present invention, with the cap shown prior to being secured onto the pill bottle.

FIG. 3A is the front view of FIG. 3, but is shown after the first embodiment of the cap is releasably secured onto the prior art pill bottle.

FIG. 3B is a top view of the cap of FIG. 3A.

FIG. 4A is a first side view of the compact cap according to the present invention, and the prior art pill bottle, as shown in FIG. 3A.

FIG. 4B is a rear view of the compact cap and pill bottle, as shown in FIG. 4A.

FIG. 4C is a second side view of the compact cap and the pill bottle, as shown in FIG. 4A.

FIG. 4D is a cross-sectional view through the compact cap and the pill bottle, as shown in FIG. 4A.

FIG. 4E is a bottom view of the compact cap and the pill bottle, as shown in FIG. 4A.

FIG. 4F is a bottom perspective view of the prior art pill bottle and the cap embodiment of FIG. 4A, showing four clamps members protruding to a locked position within the shroud, and engage with the lip of the pill bottle between hook members formed on the lip.

FIG. 4G is a perspective view of the bottom of the cap embodiment of FIG. 4A, shown detached from a different prior art pill bottle, which has a lip at its upper end formed without any hook members, and where the four clamps member of the cap protrude to an unlocked position.

FIG. 4H is a perspective view showing the cap embodiment of FIG. 4A seated upon the prior art pill bottle of FIG. 4G, with the clamp members in an unlocked position, being disengaged from the lip of the pill bottle.

FIG. 4I is the perspective view of FIG. 4H, but showing the clamp members in a locked position, being engaged with the lip of the pill bottle.

FIG. 5 is the cross-sectional view of FIG. 4D, but shown enlarged.

FIG. 5A is a top perspective view of the cap embodiment of FIG. 4A and the prior art pill bottle, shown with the shroud of the cap removed.

FIG. 6 illustrates a portion of the cap and pill bottle shown in FIG. 5, with two clamp members engaged with the lip of the prior art pill bottle, and the corresponding drive member threadably engaged with the clamp members, and with the drive member being rotated to begin actuating the clamp members to initiate disengagement from the lip of the pill bottle.

FIG. 6A is an enlarged detail view of an alternate embodiment of the clamp members of FIG. 6, having a longer lower horizontal leg to be able to engage the annular lip of the pill bottle and remain clear of its laterally extending hook members.

FIG. 7 illustrates the top portion of the cap and pill bottle shown in FIG. 6, but is shown with the clamps having been actuated sufficiently to become disengaged from the annular lip of the pill bottle.

FIG. 8 illustrates a bottom view of the drive member of FIG. 7, showing helical threads that protrude from its flat surface that may engage helical teeth formed on each of the clamp members, which may drive the clamp members between locked and unlocked positions when the drive member is rotated or counter-rotated.

FIG. 9 illustrates a top view of the drive member and clamp members of FIG. 7, showing the teeth of the clamp members, and showing the clamp members slidably mounted with respect to the cover member of the cap.

FIG. 10 a side view of one clamp member and the cover member, as shown in FIG. 9.

FIG. 11 is a detail view of the clamp member, as seen in FIG. 7.

FIG. 12 illustrates a smart phone with an App icon titled “My Pill Bottles,” which may be toggled to launch a program that may interact wirelessly with a cap embodiment of the present invention.

FIG. 13 illustrates the smart phone of FIG. 12, but after the “My Pill Bottles” app has been launched, which may result in the display of a screen that may list each of the pill bottle caps being used on a pill bottle containing prescription medicines for the user.

FIG. 14 illustrates the smart phone of FIG. 13, but after “Pill Bottle #2” has been selected, which may result in the display of a screen that may list the scheduled times for taking the prescribed dosage of medicine, and whether the schedule has been kept, based upon recorded opening of the cap.

FIG. 15 illustrates a cross-sectional view of the prior art pill bottle of FIG. 4G and a second embodiment of a cap in accordance with the present invention, shown with the clamp member disengaged from the lip of the pill bottle.

FIG. 16 illustrates an exploded view of the component parts of the cap embodiment of FIG. 15.

FIG. 16A is an enlarged detail view of the actuator shown within FIG. 16.

FIG. 17 is an enlarged perspective view of the cap embodiment shown in FIG. 15.

FIG. 18A is an enlarged top perspective view of the pill bottle cover shown within the exploded view of FIG. 16.

FIG. 18B is a bottom perspective view of the pill bottle cover of FIG. 18A.

FIG. 19A is an enlarged top perspective view of the drive member shown within the exploded view of FIG. 16.

FIG. 19B is a bottom perspective view of the drive member of FIG. 19A.

FIG. 20A is an enlarged top perspective view of the lower housing shown within the exploded view of FIG. 16.

FIG. 20B is a bottom perspective view of the lower housing shown in FIG. 20A.

FIG. 21A is an enlarged top perspective view of the upper housing shown within the exploded view of FIG. 16.

FIG. 21B is a bottom perspective view of the upper housing shown in FIG. 21A.

FIG. 22A is an enlarged top perspective view of the shroud shown within the exploded view of FIG. 16.

FIG. 22B is a bottom perspective view of the shroud shown in FIG. 22A.

FIG. 23 illustrates a cross-sectional view of the prior art pill bottle of FIG. 4G and a third embodiment of a cap in accordance with the present invention, shown with the clamp members engaged with the lip of the pill bottle.

FIG. 24 illustrates an exploded view of the component parts of the cap embodiment of FIG. 23.

FIG. 24A is an enlarged perspective view of the bevel gear shown in FIG. 24.

FIG. 24B is an enlarged perspective view of one of the clamp members shown in FIG. 24.

FIG. 25 is an enlarged perspective view of the cap embodiment shown in FIG. 23.

FIG. 26A is an enlarged top perspective view of the pill bottle cover shown within the exploded view of FIG. 24.

FIG. 26B is a bottom perspective view of the pill bottle cover of FIG. 26A.

FIG. 27A is an enlarged top perspective view of the lower housing shown within the exploded view of FIG. 24.

FIG. 27B is a bottom perspective view of the lower housing of FIG. 27A.

FIG. 28A is an enlarged top perspective view of the drive member shown within the exploded view of FIG. 24.

FIG. 28B is a bottom perspective view of the drive member shown in FIG. 28A.

FIG. 29A is an enlarged top perspective view of the upper housing shown within the exploded view of FIG. 24.

FIG. 29B is a bottom perspective view of the upper housing shown in FIG. 29A.

FIG. 30 is a view illustrating a fourth embodiment of a cap in accordance with the present invention, shown with the clamp members engaged with the lip of the pill bottle.

FIG. 31 is the view of FIG. 30, shown with the clamp member in the unclamped position.

FIG. 32 is the view of FIG. 30, shown with a linear actuator for actuating the clamp members.

FIG. 33 is the view of FIG. 32, shown with the clamp member after being actuated into the unclamped position.

FIG. 34 is a schematic illustration showing an exemplary computing unit capable of being programmed by the instructions of the software usable with a cap embodiment of the present invention, and which may include personal computers, cellular phones, and other smart mobile devices.

### DETAILED DESCRIPTION OF THE INVENTION

As used throughout this specification, the word, “may” is used in a permissive sense (i.e., meaning having the potential to), rather than the mandatory sense (i.e., meaning must). Similarly, the words “include”, “including”, and “includes” mean including but not limited to.

The phrases “at least one”, “one or more”, and “and/or” are open-ended expressions that are both conjunctive and disjunctive in operation. For example, each of the expressions “at least one of A, B and C”, “one or more of A, B, and C”, and “A, B, and/or C” means all of the following possible combinations: A alone; or B alone; or C alone; or A and B together; or A and C together; or B and C together; or A, B and C together.

Also, all references (e.g., patents, patent publications, and non-patent literature) that are cited within this documents are incorporated herein in their entirety by reference.

Furthermore, the described features advantages, and characteristics of any particular embodiment disclosed herein, may be combined in any suitable manner with any of the other embodiments disclosed herein.

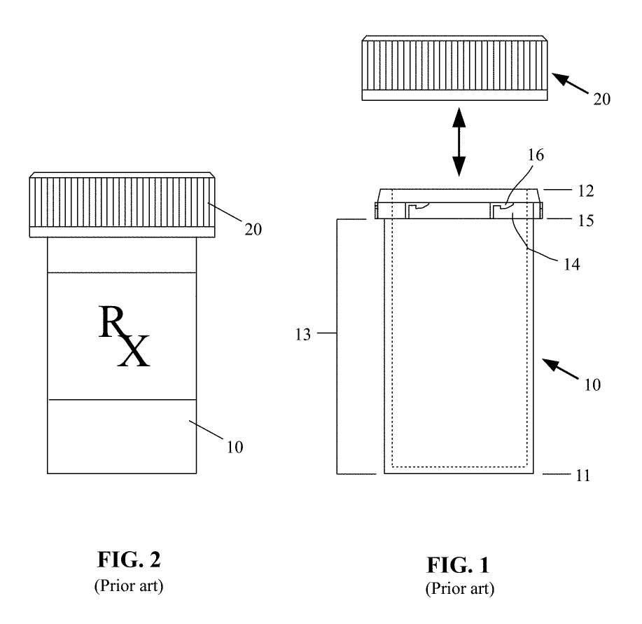

FIG. 1 illustrates a prior art pill bottle 10 that is typically used to store pills, tablets, capsules, and other similar medicines (generally referred to hereinafter as a “pill” or “pills”), and also illustrates a child-proof safety cap 20 prior to being releasably coupled to the pill bottle. The prior art cap 20 is shown secured to the pill bottle 10 in FIG. 2. As seen in FIG. 1, the prior art pill bottle 10 may include a generic cylindrical container portion 13 that extends upwardly from a bottom end 11 towards a top end 12. Proximate to the upper end 12, an annular protrusion 14 may extend radially outward to form a corresponding annular lip 15. A plurality of laterally extending hook members 16 may protrude from the annular protrusion 14 and may be used to releasably secure the cap 20 to the pill bottle 10, using corresponding features within the cap's interior.

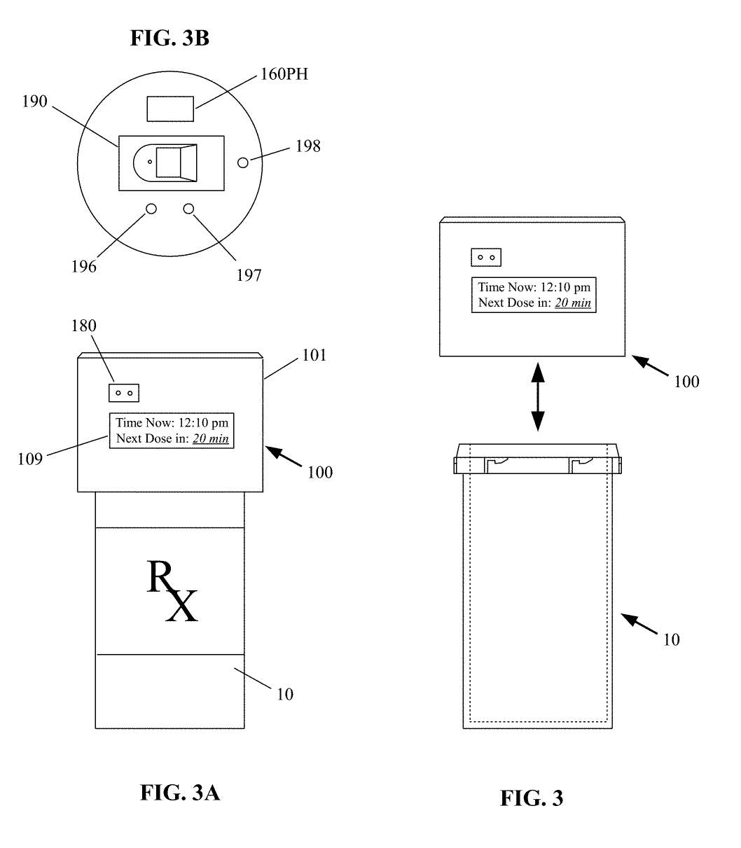

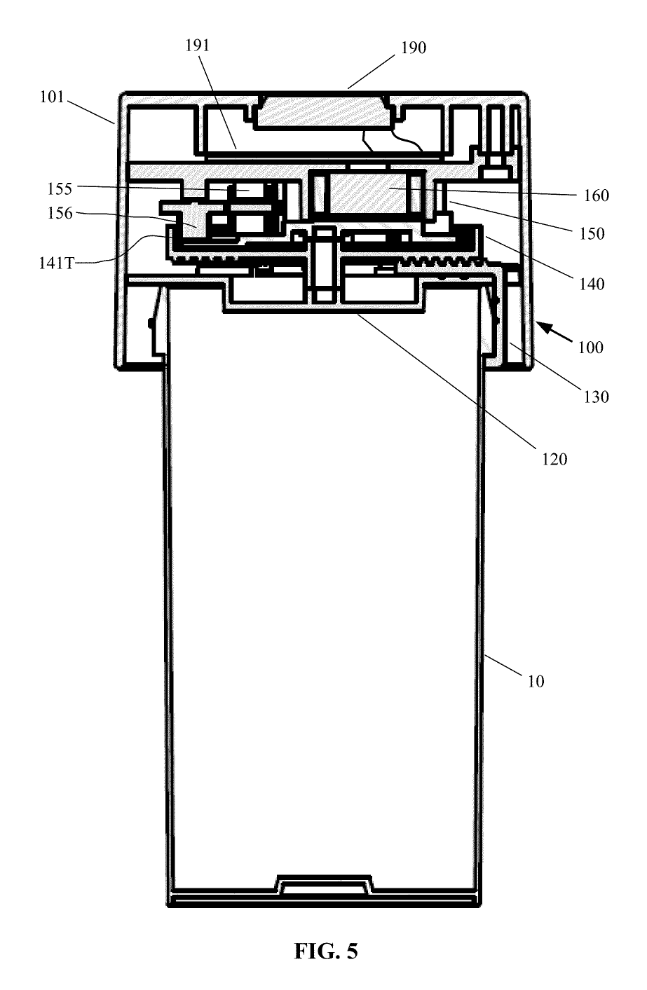

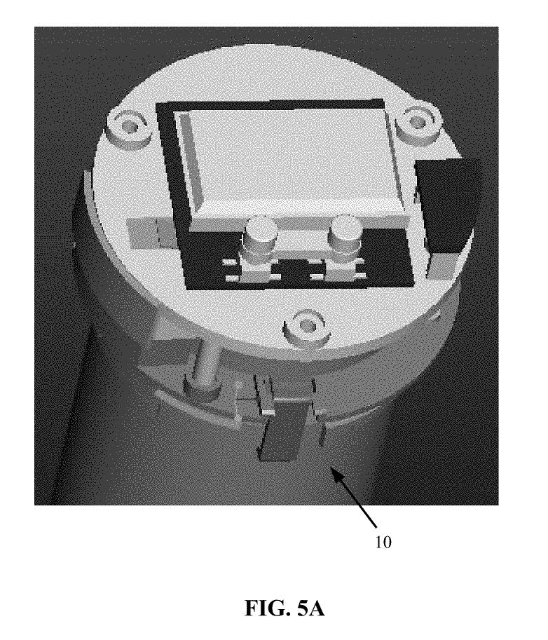

FIG. 3 also shows the prior art pill bottle 10, but further illustrates a cap 100 of the present invention that may be secured to the lip of the pill bottle (FIG. 3A), and which requires biometric authentication to actuate its locking mechanism, to permit its removal therefrom. FIG. 5 shows a cross-sectional view through the component parts of the cap 100 of the present invention, and through the prior art pill bottle 10.

The component parts that may be used in and specifically oriented to form the cap 10, may be particularly configured and positioned to produce a compact cap with a minimized height and volume. As seen in FIG. 5, the cap 100 may principally include a bottle cover 120, two or more clamp members 130 (note that only one clamp member is shown in FIG. 5), a drive member 140, an actuator 150, a battery 1.60, a printed circuit board 191 with certain electrical components thereon, a fingerprint reader 190, and a shroud 101.

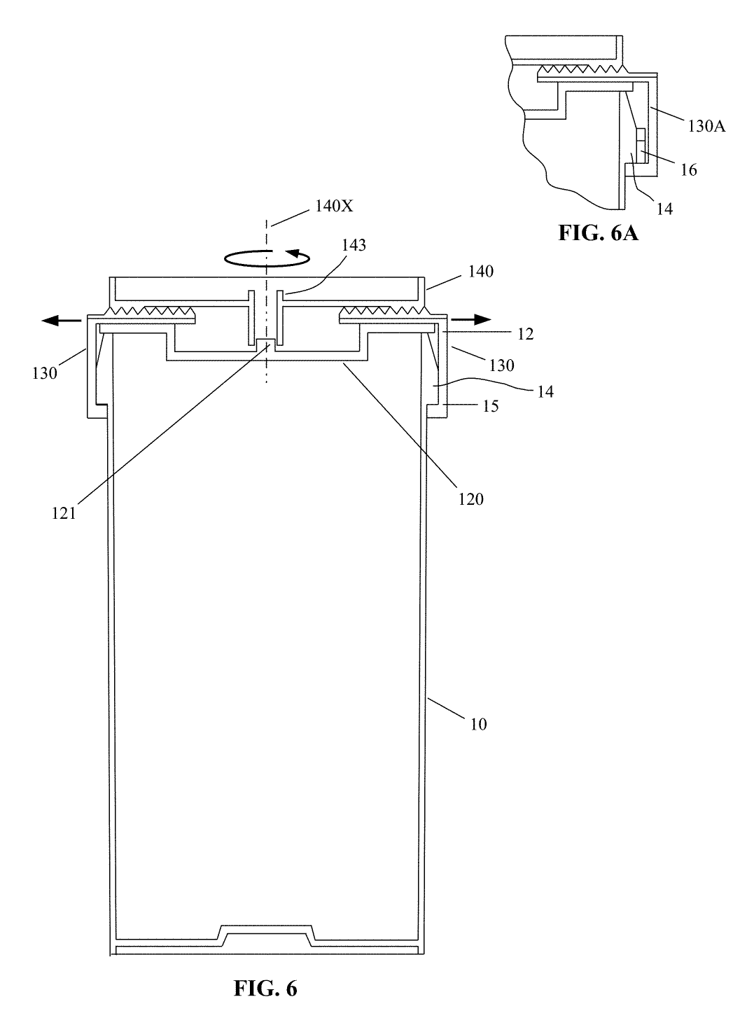

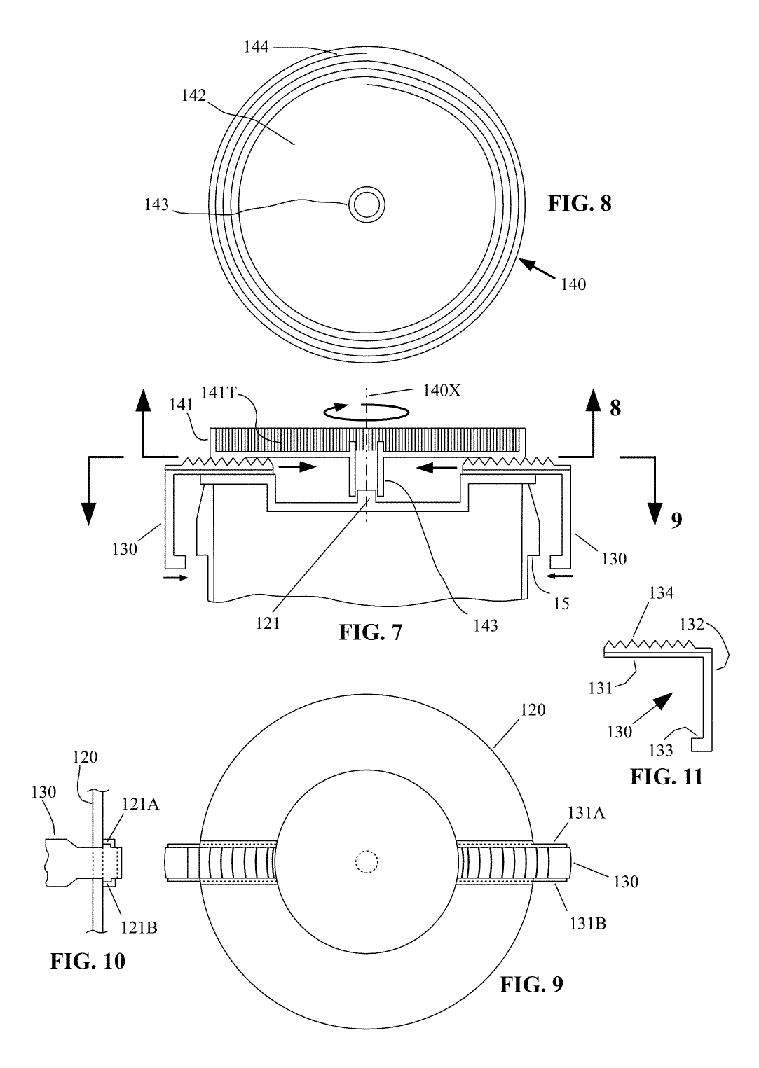

As seen, in FIG. 6 and FIG. 7, the bottle cover 120 may rest upon the second end 12 of the pill bottle 10, and the clamp members 130, which may be slidably received by the bottle cover, may furthermore be configured for a portion thereof to engage the sides of the annular protrusion 14, and/or the lip 15, as discussed hereinafter. Where an odd number of clamp members are used (e.g., 3, 5, 7, etc.), they may be positioned to be equally spaced about the pill bottle (i.e., 120 degrees apart, for 3 clamp members, or 72 degrees apart for 5 clamp members, etc.). Where an even number of clamp members 130 are used for the cap arrangement (e.g., 2, 4, or even 20 clamp members), the cap 100 may have pairs of clamp members that engage on opposite sides of the pill bottle 10, and where more than two pairs are utilized, the clamp pairs may be equally spaced, about the axis of the cap 100. Any number of clamp members 130 could be used. (Note, that a greater number of clamp members 130 may be more effective at countering a person attempting to pry open each of the clamp members to defeat the safety cap 100 by inserting a wedge member between the pill bottle 10 and the clamp member, which may furthermore be thwarted by a close fitting shroud 101). However the number and positioning of the clamp members, in one embodiment, may be limited and determined by the number of hook members 16 on the annular protrusion 14 on the pill bottle, or by other similar features on other pill bottle types. For example, the prior art pill bottle 10 shown in FIG. 1 has six laterally extending hook members 16, which are equally spaced on the annular protrusion 14, thus leaving space therebetween for two to six clamp members 130 that may be spaced apart to engage the annular protrusion 14 and/or the lip 15 (i.e., between those hook members).

As seen in FIG. 9. FIG. 10, and FIG. 11, each of the clamp members 130 may generally be C-shaped, having an elongated upper leg 131, a vertical leg 132, and a short horizontal lower leg 133. (Note that the use herein of the terms “upper,” “lower,” and “vertical” are merely intended to be descriptive for the reader, based on the depiction of those features within the drawing figures, and are not intended to limit the orientation with which the pill bottle and cap of the present invention may be utilized and operated). The distance between the bottom of the upper leg 131 and the top of the lower leg 133 may be formed to correspond to the extent of the annular protrusion 14 in the axial direction (i.e., 140X) of the prior art pill bottle 10.

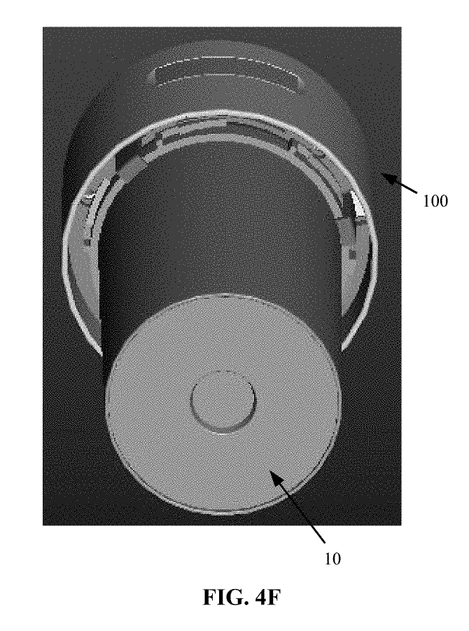

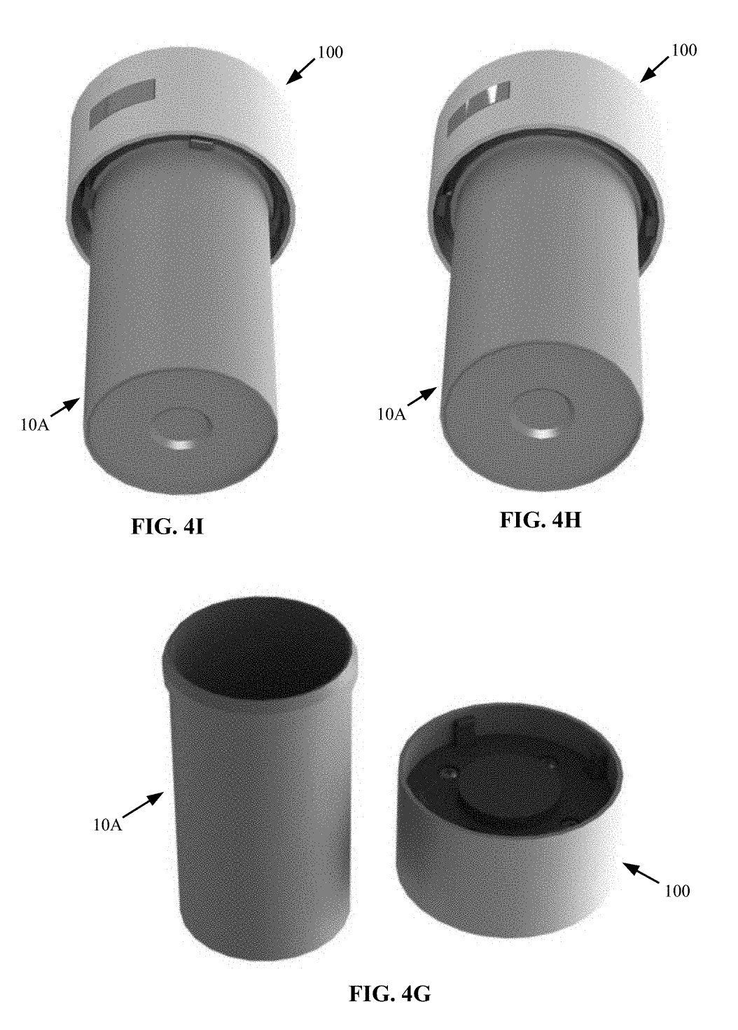

There are a few options for the length of the short horizontal lower leg 133. The leg 133 may be sized to be slightly less than, or substantially the same length as the extent to which the annular protrusion protrudes outwardly from the cylindrical body of the pill bottle. For either of these embodiments, care would need to be taken by the elder user when placing the cap 100 onto the pill bottle 10, to ensure that the clamp members 130 would be positioned (i.e., clocked) to fall between the laterally extending hook members 16 on the annular protrusion 14, in order to be able to properly engage the annular protrusion 14 and the lip 15 of the pill bottle. Note that such care by the elderly user would be obviated if the cap were to be placed upon the prior art pill bottle 10A shown in FIG. 4G, which does not have any protruding hook members.

Alternatively, to provide a cap embodiment that may be configured for more universal usage with respect to an assortment of different prior art pill bottles, the length of the leg 133 may be sized to be the slightly larger than the extent to which both the annular protrusion and the laterally extending hook members 16 protrude outwardly from the pill bottle container. In this embodiment, care would not be required by the elder user when placing the cap onto the pill bottle. With this embodiment, the clamp members 130 would be able to engage the lip 15 (although it would not be in contact with the annular protrusion 14), irrespective of the relative positioning (i.e., the clocking) of the clamp members with respect to the laterally extending hook members 16 on the annular protrusion 14, because the vertical leg 132 of the clamp members would be positioned to be clear of the annular protrusion 14, and may either contact or also be clear of the hook members 16 (compare the clamp member 130A and arrangement shown in FIG. 6A, with the clamp 130 and arrangement shown in FIG. 6). With this option, any number of clamp members 130 may be utilized, and they furthermore would not need to be selectively positioned to accommodate a particular spacing when seated upon the pill bottle, and need not be equally spaced about the axis of the cap 100.

Each of the clamp members 130 may be slidably received by the bottle cover 120, using any suitable sliding arrangement known in the art. Merely to be representative, the embodiment illustrated in FIGS. 9-10, shows each of the clamp members 130 may have a slot (131A and 131B) on each side of the leg 131 that may be slidably received within a corresponding pair of recesses (121A and 121B) formed in the bottle cover.

The drive member 140 (FIGS. 7-8) may include a cylindrical portion 41 that may extend from a base plate 142, and which cylindrical portion may be formed to be concentric to a hub 143 that may protrude from the base plate. The drive member may have a plurality of gear teeth formed at a suitable position thereon that may be driven by gear teeth of a corresponding actuator. For the drive member 140 shown in FIG. 7, the interior surface of the cylinder 141 may have a plurality of gear teeth 141T formed thereon. The side of the base plate 142 opposite from the interior of the cylindrical portion 141 may have helical threading 144 protruding therefrom. The top of the elongated upper leg 131 of each of the clamp members 130 may also have a plurality of teeth 134 formed thereon, which are configured to correspond to and be engaged by the helical threading 144 on the drive member 140.

Therefore, as seen in FIG. 6, rotation of the drive member 140 about axis 140X may cause each of the clamp members 130 to simultaneously translate radially outward from the center of the bottle cover 120 to become disengaged from the annular protrusion 14 and its lip 15 on the pill bottle 10, and permit removal of the cap 100 therefrom.

After the cap 100 has been placed back onto the pill bottle 10, the drive member 140 may be counter-rotated about axis 140X, as shown in FIG. 7 (i.e., rotated in an opposite direction as previously done for disengagement), to cause each of the clamp members 130 to simultaneously translate radially inward towards the center of the pill bottle 10 to reengage the annular protrusion 14 and lip 15 on the pill bottle 10, and prevent unauthorized removal of the cap 100 therefrom.

The rotation and counter-rotation of the drive member 140 may be provided by an actuator (e.g., actuator 150), which in one embodiment may be an electrically powered rotary actuator that may be powered by the battery 160, or may be powered by any other suitable power source. The battery 160 utilized may be quite small, and may be a watch battery. The battery used may be any suitable battery type, and may furthermore be a rechargeable battery. In one embodiment the battery may be 3.7 V, 380 mAh lithium polymer battery. The power may also be supplied by a photocell 160PH (FIG. 4A) that may convert and store light energy received thereon into electrical power. The power from the photocell 160PH may be used to power the device, and/or to recharge the battery.

The rotary actuator may be coupled directly to the hub 143 of the drive member to cause such rotation and counter-rotation, which may require the shaft of the actuator to be co-axial with the hub 143 of the drive member 140. However, such an arrangement may not be as compact as is desired, because the axial direction of the shaft of the rotary actuator 150 may be its longest dimension. Therefore, a rotary actuator 150 may alternatively be indirectly coupled to the hub 143 of the drive member 140, to change the plane of rotation. The shaft of the rotary actuator 150 may be at a 90 degree angle to the axis of the hub of the drive member 140, and may also be displaced laterally therefrom, and may thus be positioned at the same level as the battery 160, as shown in FIG. 5. A suitable gear or set of gears may be used to transmit the rotary motion from the rotary actuator 150 to the gear teeth 141T formed on interior surface of the cylinder 141 of the drive member 140. For example, as seen in FIG. 5, a worm gear 155 may be secured onto the end of the shaft of the actuator 150, and may be used in combination with a corresponding wheel gear 156 to form a worm and gear set (see e.g., U.S. Pat. No. 3,535,948 to Winzeler). Another wheel gear may be used as an intermediary between the worm and gear set, and the teeth 141T of the drive member 140, as required, to accommodate suitable positioning of the cap 100 components within the tight confines of the space within the envelope created by the shroud 101. Furthermore, to support and stabilize the rotational and counter-rotational movements of the drive member 140, the hub 143 of the drive member 140 may be pivotally mounted with respect to a shaft 121 formed on the bottle cover 120 (FIG. 7).

Commands for the rotary actuator to either rotate or counter-rotate to respectively position the clamp members in the unlocked or locked positions of the cap 100 with respect to the prior art pill bottle 10 (see FIG. 4H and FIG. 4I) may be derived from a microprocessor and/or other circuitry that may be on the circuit board 191. The commands may originate from the fingerprint reader 190, which components may be communicatively linked with each other and with the power source. The fingerprint reader may be as disclosed in U.S. Pat. No. 5,546,471 to Merjanian, or it may utilize any other fingerprint reader technology currently known in the art or which may be developed later. Moreover, in another embodiment, biometric authentication may additionally or alternatively be provide using a voice recognition module, and may be as disclosed, for example, by U.S. Pat. No, 6,791,529 to Shteyn, and/or by U.S. Pat. No. 4,363,102 to Holmgren, and/or by U.S. Pat. No. 5,293,452 to Picone.

Because the cap 100 of the present invention is not merely actuating an elongated latch bolt into an oversized hole, and instead must move the clamp members 130 a discrete amount to appropriately grasp the relatively small lip 15 of the prior art pill bottle 10 to secure the cap thereto, the rotary actuator 150 may need to be turned on and turned off to impart a precise amount of sliding movement to each of the clamp members 130.

If the inward sliding of the clamp members 130 is too little, its grasp of the pill bottle may be insufficient to positively engage the annular protrusion 14 and lip 15, and could be defeated by an energetic child. Conversely, if the inward sliding of the clamp members 130 is too much, the clamp members could damage the pill bottle, potentially cracking it, which could allow unauthorized access to its contents, or could cause damage to the cap 100, particularly the rotary actuator 150.

Therefore, in one embodiment, the simultaneous outward sliding movement and the inward sliding movement of the clamp members 130 may be set (e.g., timed) to be substantially the same, and the innermost position of the vertical leg 132 of the clamp members 130 may be set at the time of manufacture of cap 100 to match the diameter of the lip 15 of the particular pill bottle 10 it is designed to be secured onto. The circuitry may include a memory, and the processor may be programmed such that the rotary actuator 150 may default to alternate between rotation and counter-rotation for successive instances of being powered up (i.e., alternately actuated for inward translation and outward translation of the clamping members 130). The positioning of the helical threads 144 to be at the outer diametrical periphery of the base plate 142 of driving member 140 to thereat have a relatively large nominal diameter (i.e., radius of curvature) may serve to reduce the sensitivity in the positioning of the clamp members due to small timing errors. The actuator may also be set to rotate at a fairly slow speed to further reduce timing errors, as it may be satisfactory in most cases for the cap to require a couple of seconds to move from the locked to the unlocked positions. Any other suitable method(s) of indexing the positioning of the clamp members 130 for the locked and unlocked position may also be used (e.g., using the total amount of rotation by the rotary actuator for locking and subsequent locking).

In another embodiment, such precise timing of the power to the actuator (or use of the alternate indexing methods) to produce substantially the same amount of translation of the clamp members 130 in both directions may not be required, as the cap 100 may instead be configured to be instantly and universally utilized on a range of different pill bottle diameters. This may be accomplished through the use of a pressure sensor that may sense the force exerted upon the clamp members 130 (or to sense resistance to turning by the rotary actuator), which sensing may be used, upon reaching a threshold force/resistance level, to stop the rotary actuator and the corresponding translations of the clamp members. With this embodiment, when the patient or authorized individual places his/her finger onto the fingerprint reader 190, and the person's identity is subsequently authenticated, the rotary actuator 150 may be powered on to rotate the drive member 140 a sufficient amount so that the clamp members 130 are translated to their outermost extreme positions (i.e., to disengage from the largest diameter pill bottle for which it is designed). When the cap 100 is subsequently placed back onto a different sized pill bottle (e.g., a pill bottle smaller than the largest size), and the rotation of the rotary actuator is initiated, it may continue to counter-rotate and cause continued inward translation of the clamp members 130 until they grasp the lip 15 of the particular sized pill bottle upon which it may now be seated, and upon reaching the threshold pressure level, the actuator may be powered off.

Initiating the rotation of the shaft of the actuator 150 for either locking or unlocking of the cap 100 with respect to the pill bottle 10, may be through one of several different modes of operation.

In a first mode of operation, the user may only need to place his/her finger upon the fingerprint reader to initiate the rotary actuator to rotate or counter-rotate for either the locking or the unlocking operation. If the person's fingerprint is recognized and authenticated as an authorized user, a light 196 (e.g., an LED) protruding out the top of the shroud 101 may light up a green color. If the person is not authenticated, light 197 may light up a red color, and the actuator will not be actuated.

In another mode of operation, the cap 100 may include a sensor (pressure or proximity) that may detect when the cap 100 has been placed back onto the pill bottle 10, with the bottle cover 120 resting on the second end 12 of the bottle, which occurrence may automatically trigger powering up of the rotary actuator to initiate locking of the cap thereon.

In another embodiment, rather than requiring biometric authentication for locking of the cap 100 on the pill bottle 10, and rather than utilizing an extra sensor to automatically trigger such locking, a user interface button/switch 198 protruding out from the top of the shroud 101 (FIG. 4A) may be toggled to manually power up the rotary actuator 150 to initiate locking of the cap 100.

Another button, or the same button 198 may be used to initiate recording of fingerprint data of a new authorized user which may be when the cap is already secured to the pill bottle. The first time the cap 100 is utilized, pressing the button 198 may allow the initial user to scan his/her fingerprint to become the authorized user, which may presumably be the patient-purchaser of the cap. Thereafter, when the button 198 is toggled, the patient-owner would first use his/her fingerprint and be authenticated as permitting the addition of another authorized user, and then the individual that is to become an authorized user (e.g., a care-giver) would subsequently place their finger upon the reader 190 and have his/her fingerprint scanned.

Another embodiment of the device may include a speaker and circuitry configured to emit sound, to provide an audible alarm when the cap 100 has not been secured back onto the bottle 10, which may utilize a proximity sensor, or which may simply determine if the cap has remained unlocked for a period of time that exceeds a threshold amount of time.

Another embodiment may include a digital display window 109 that may be configured to present information to the user. The digital display 109 may be configured to normally display the current time of day, as seen in FIGS. 3-3A (e.g., “12:10 pm”), and may also display the time remaining until the next dose is due to be taken (e.g., “Next Dose in: 20 minutes”). When the time to take the next dose of medication is reached, the microprocessor may be configured to cause the speaker to emit one or more beeps or other sounds to alert the user. If the pill bottle cap is not accessed to take the dosage, after a period of time, the display may also flash a warning to the user, such as “12:30 dosage not taken.” The microprocessor may continue to periodically cause the beeping sound to warn the user of the missed dosage. The frequency of the dosage (e.g., four times per day, every 4 hours) may be programmed into the cap using a port 180, which may also be used for upgrades to firmware or software, or for accessing data stored therein, etc. The port may be any suitable port known in the art. Compliance with the dosage frequency may be determined based upon the times that the pill bottle cap has been accessed by the user. For example, if the medication is scheduled to be taken 4 times per day, every 4 hours, and if the patient neglects to take the third dose of medication on time, and is overdue by perhaps two hours, the microprocessor may automatically reset the time for the next dose to be four hours after the pill bottle cap is next accessed. Also, once the microprocessor determines that the patient has neglected to take the medication on time, it may trigger one of the LEDs to flash on and off to alert and otherwise notify the patient, which may also be helpful in the case where a patient is required to take several medications, each of which may utilize a cap embodiment of the present invention. An additional yellow LED may be utilized to flash the warning, or one of the other described LEDS (i.e., the green and red LEDs 296/297) may be used to flash the warning, any or all of which may also be configured to flash multiple different colors as needed.

The power source and the microprocessor may operate to provide for a conventional “power save” mode to conserve power when the cap 100 is not in use. When in the power save mode, the cap 100 may make minimal use of the digital display and aural warnings (i.e., only powering the display periodically, and with a lengthy off time, or alternatively only powering the display when one of the buttons on the cap 100 is toggled). In another embodiment, the microprocessor may be configured to power down the display and minimize all non-essential power usage a short time after the cap 100 has been accessed, such as 15 seconds after the cap has been once again been secured to the pill bottle, or 30 seconds thereafter, or some other suitable time period.

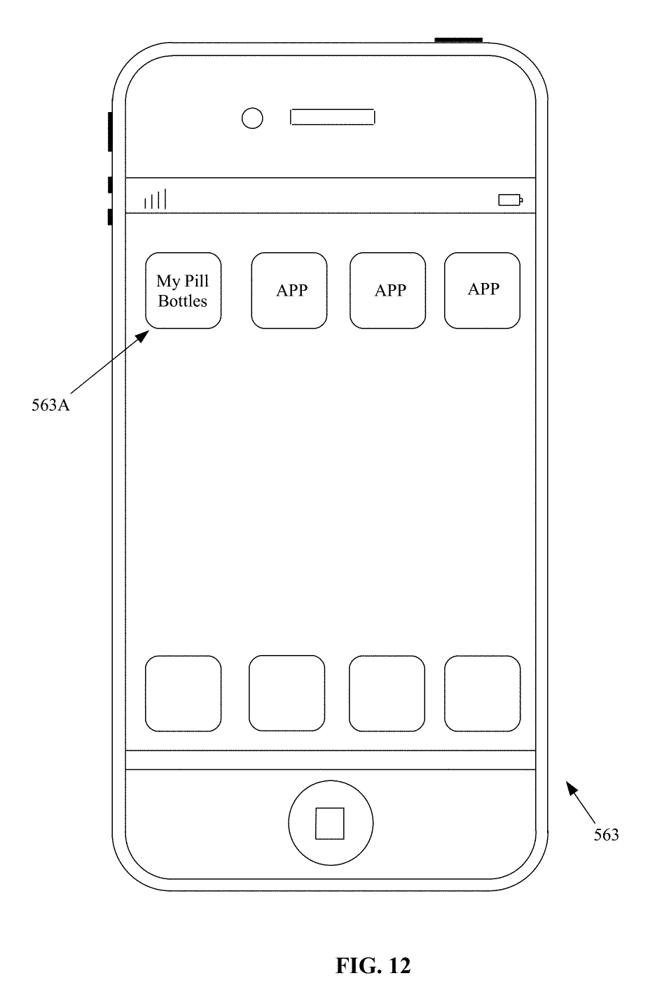

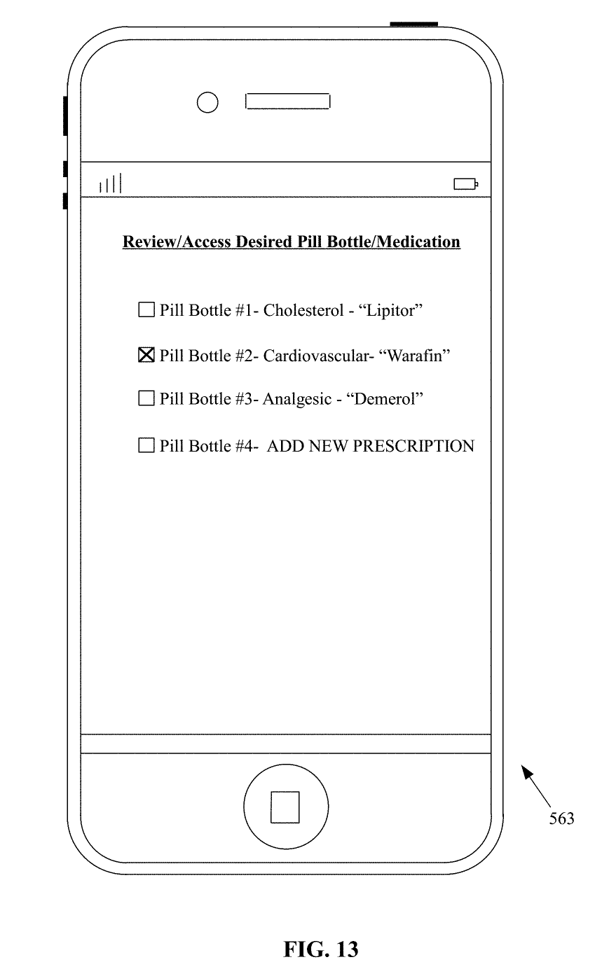

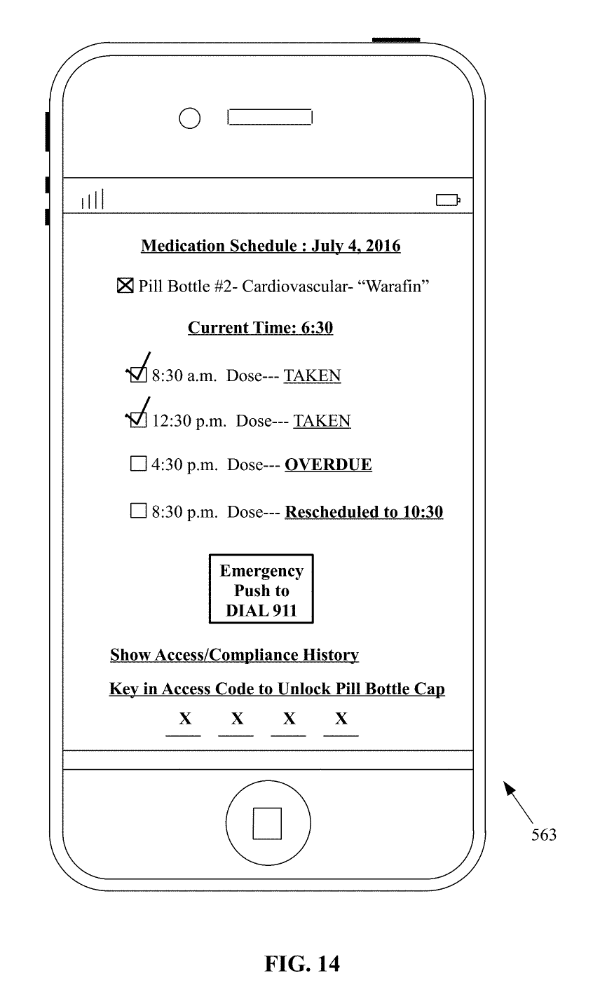

In another embodiment of the device, the microprocessor and/or other circuitry may enable Blue Tooth capabilities to permit transmitting of information via a wireless connection to an application running on a smart phone 563 or other smart electronic device, as shown in FIGS. 12-14. The App icon (e.g., “My Pill Bottles” 563A in FIG. 12) may be toggled to launch the program, which may then display the screen shown in FIG. 13. As seen therein, the screen may display a list of the medications stored in separate pill bottle with a corresponding cap 100 that are currently scheduled to be taken by the user. By selecting any one of the medications using the touch screen (e.g. “Pill Bottle #2—Cardiovascular—‘Warfarin’,” shown with an X-mark therein”), the user or another person designated to monitor the patient (e.g., an elderly patient's son, daughter, nurse, caregiver, etc.), can track compliance with the periodic opening/accessing of the pill bottle cap 100, as shown in FIG. 14. A complete history of the cap may be accessed therefrom, by toggling the button labeled “Show Access/Compliance History,” which may list/include the number and times/dates that the safety cap has been cycled open and closed, along with the schedule dosage times and dates.

As discussed hereinabove and shown within FIG. 14, the App may also track and reschedule the dosages in the scenario where the person may have forgotten to take the medication, and the time for taking it is long overdue. There may also be a button therein that may be toggled to immediately dial 911, in case of an emergency, which button may also be configured to forward critical medical information about the user, such as the ailment(s) for which medication has been prescribed, to the 911 center or directly to local EMS personnel. An option may also be provided in that screen for the user or for the user's monitor to type in a pass-code (e.g., an alpha and/or a numeric series of characters) that may send a signal to the cap to trigger unlocking of the pill bottle cap 100, for the user to gain access to the medication, absent use of his/her biometric identifying feature (e.g., his/her fingerprint).

The pill bottle cap may utilize a low energy Bluetooth (BLE) wireless networking protocol. The number of cycle times for opening/closing the cap may also be monitored by the processor so that it may trigger a reminder to the patient of the need to renew/refill the prescription. Alternatively, or additionally, the number of times the cap is cycled may be used to trigger an automatic message to the pharmacy to anticipate refilling of the prescription. Other information that may be transmitted to the user's smart device may include warnings about the current medication contained within the bottle; and important doctor-related information.

In one embodiment, a sensor may be utilized to determine when excessive loads (i.e., greater than normal handling loads) may be placed on the clamp arms, such as when a child or other unauthorized party may try to break into the pill bottle, by attempting to deflect/deform the clamp members, or by attempting to snap/shear off the clamp members. Any such attempt may be sensed by the sensor, which may trigger a warning being sent to the App on the user's and/or the monitor's cell phone, indicating that a forced entry is being attempted. Alternatively, or additionally, the sensor may trigger emission of an ear piercing sound by the speaker, and the digital display may indicate the time of day when the attempted break-in occurred, which may also be transmitted to the App on the user's and/or the monitor's cell phone.

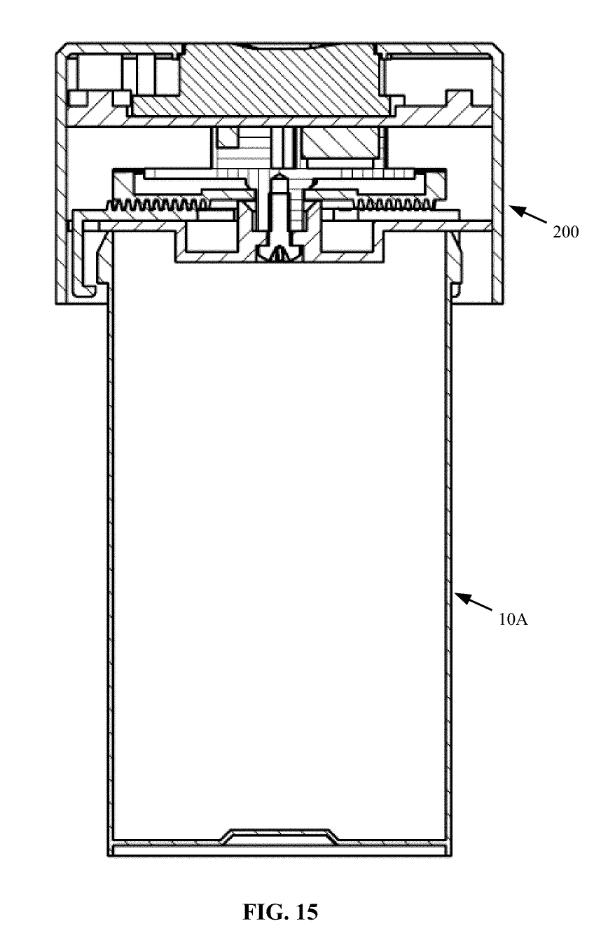

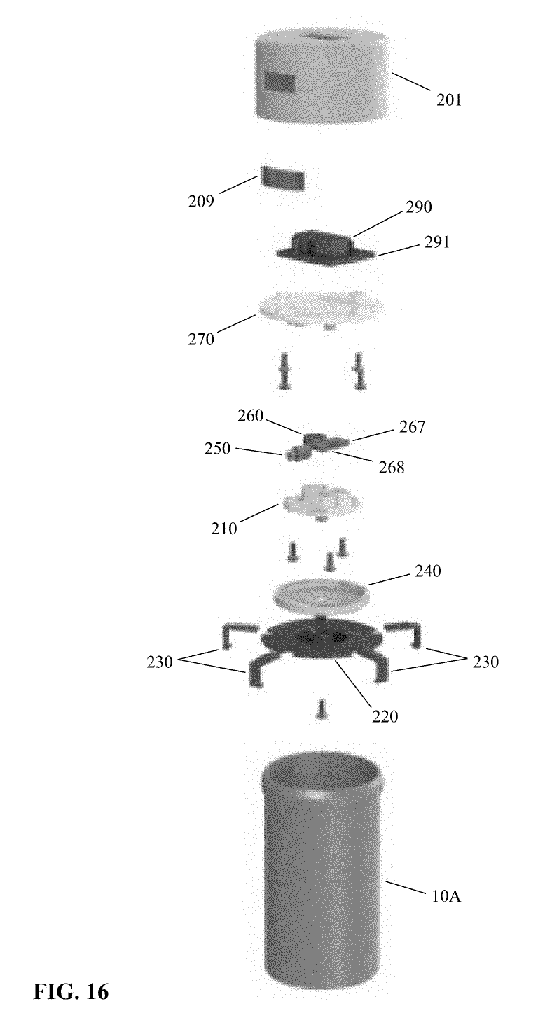

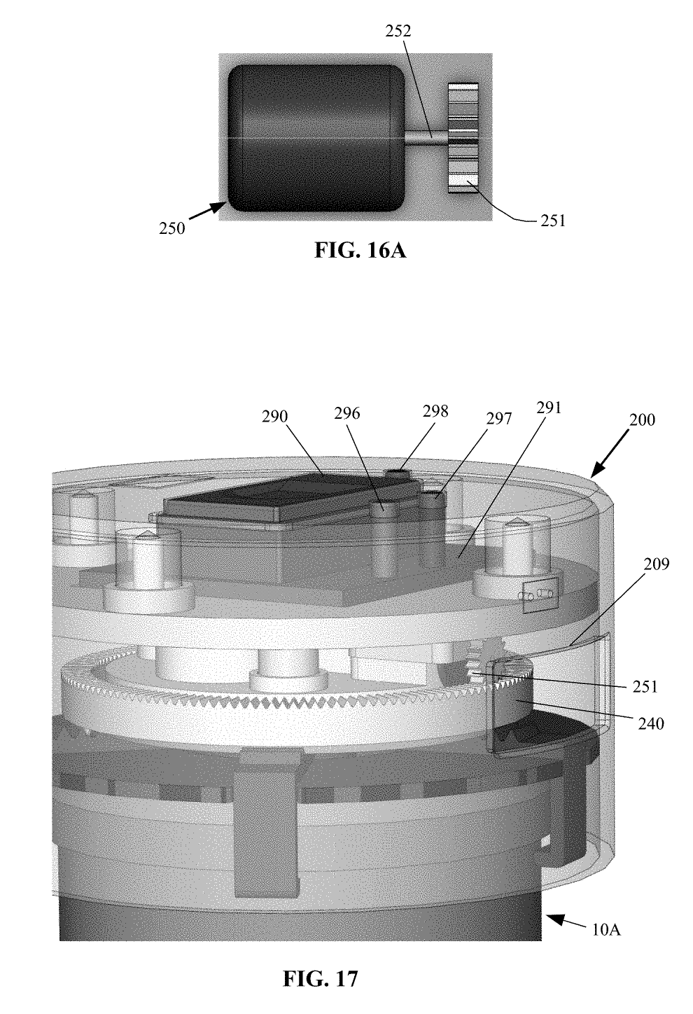

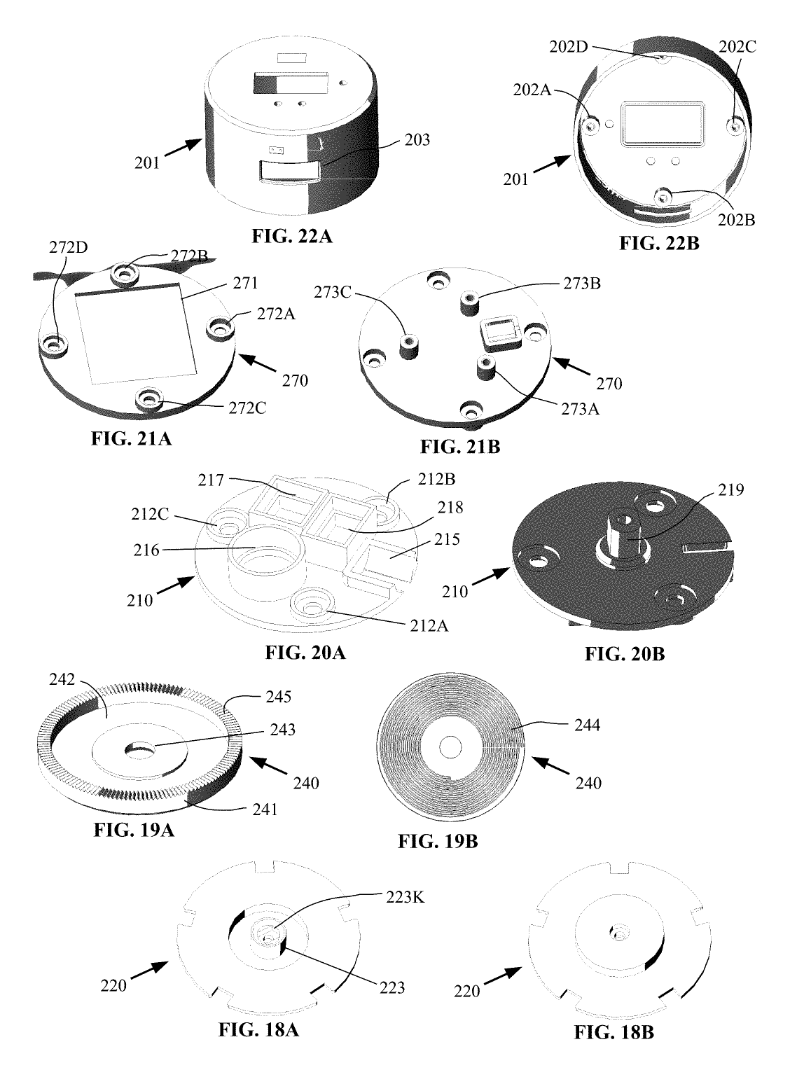

A cross-sectional view of a modified arrangement of cap 100 is shown in FIG. 15 for cap 200. An exploded view of the parts used for cap 200 is shown in FIG. 16, and a perspective view of the assembled arrangement is shown in FIG. 17. The cap 200 may utilize a bottle cover 220 and clamp members 230, each of which may be similarly constructed to the bottle cover 120 and clamp members 130 of cap 100. Cap 200 may also utilize a drive member 240, a lower housing 210, an upper housing 270, and a shroud 201, each of which is shown in the enlarged detail views of FIGS. 18A-22B.

The fingerprint reader 290 and printed circuit board 291 with associated circuitry, green and red LEDs (296/297) and user interface button 298, is configured to be seated upon the top side of upper housing 276, and may be seated within a correspondingly shaped (e.g., square) recess 271 formed therein (see FIG. 21A). The upper housing 270 may have a plurality of holes (e.g., 272A, 272B, 272C, and 272D) that may receive mechanical fasteners, including but not limited to screws, which may secure the housing and fingerprint reader assembly, within the shroud 201, with the fasteners being secured to holes within a corresponding plurality of posts (e.g., 202A, 202B, 202C, and 202D) formed in the shroud. The digital display screen 209 may then be secured within the opening 203 in the shroud 201, and may be appropriately wired. The actuator 250, battery 260, the Blue Tooth Module 267, and a microprocessor/computer chip 268 may be respectively positioned within corresponding recesses (e.g., 215, 216, 217, and 218) of the lower housing 210, and may be electrically coupled as required. The lower housing 210 may be formed with a plurality of holes (e.g., 212A, 212B, and 212C) that may receive mechanical fasteners, including but not limited to screws, which may secure the lower housing and components received thereon, to the upper housing 270, by being secured to holes within a corresponding plurality of posts formed thereon (e.g., 273A, 273B, 273C). The posts of the shroud 201 and the posts of the upper housing 270 may be formed to have a height to suitably space apart the components, while maintaining as compact an arrangement as possible. Each of the clamp members 230 may then be slidably received by the bottle cover 220. The drive member 240 may have a central hole 243 in base plate 242 for its pivotal mounting with respect to the hub 223 of the bottle cover 220, which may be accomplished such that the helical threading 244 is engaged with the corresponding teeth on the tops of the clamp members 230, the same as cap 100. The distal end of the cylinder 241 of the drive member 240 may have teeth 245 formed thereon to create a crown gear. The bottle cover 220, with the drive member 240 and clamp members 230 assembled thereon, may be mated to the lower housing 201, with the keyed post 219 on the bottom of the housing being received within a correspondingly shaped keyway opening 223K in the post 223 of the bottle cover, which may be secured using a mechanical fastener. The mating of the bottle cover 220 to the lower housing 201 may suitably position the teeth 243 of the crown gear portion of the drive member 240 to mesh with the teeth of a spur gear 251 that may be mounted on the drive shaft 252 of the actuator 250 (see FIG. 16A and FIG. 17). Operation of cap 200 may generally be similar to that of cap 100.

It should be noted that cap 200 and any of the other cap embodiments described herein may utilize any other suitable structural arrangement for supporting the critical component parts (i.e., the drive member, actuator, etc.), which may instead be mounted directly to the shroud to eliminate use of separate housings (i.e., the upper housing, the lower housing, etc.).

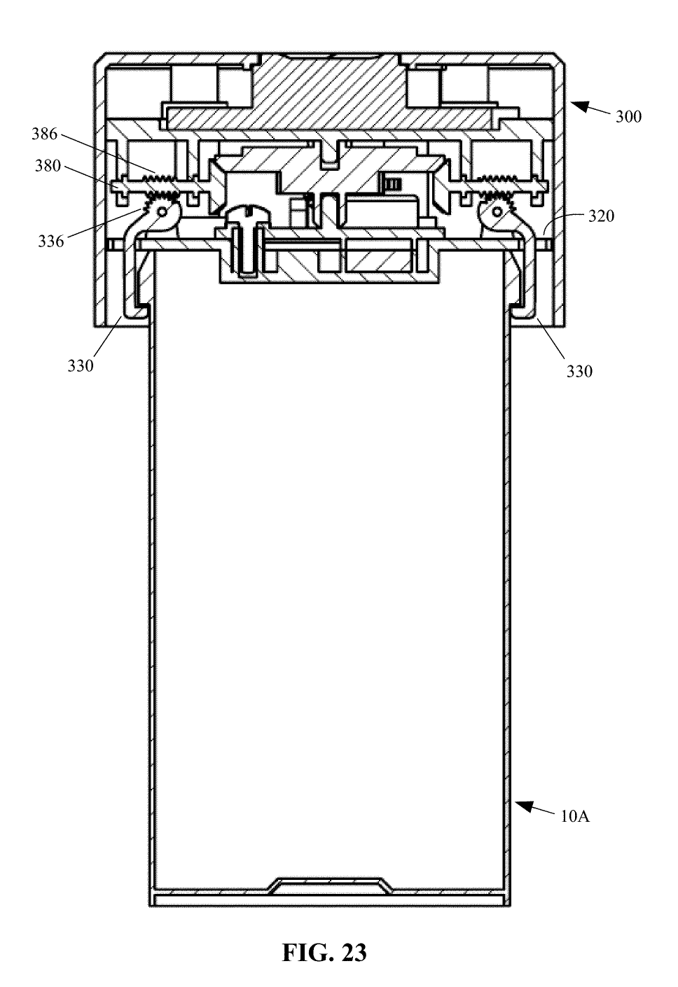

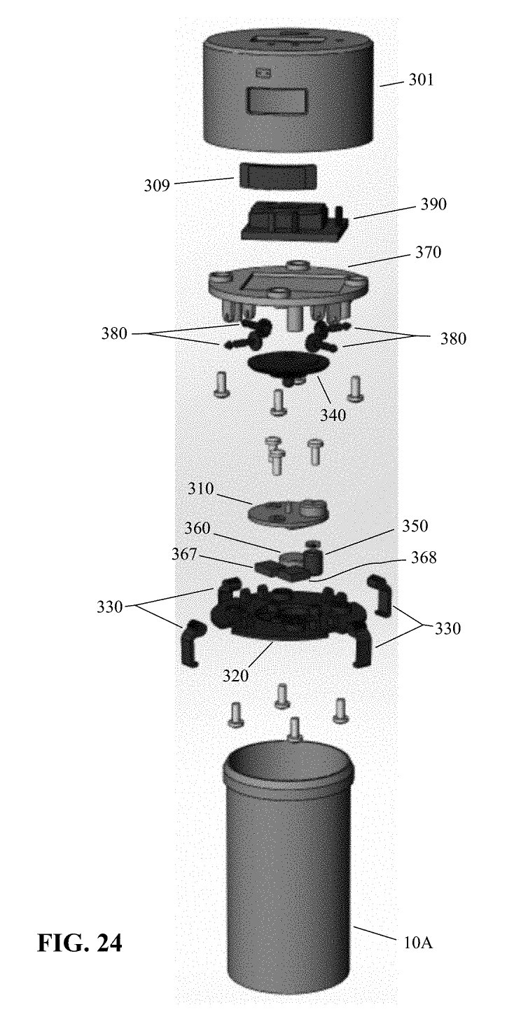

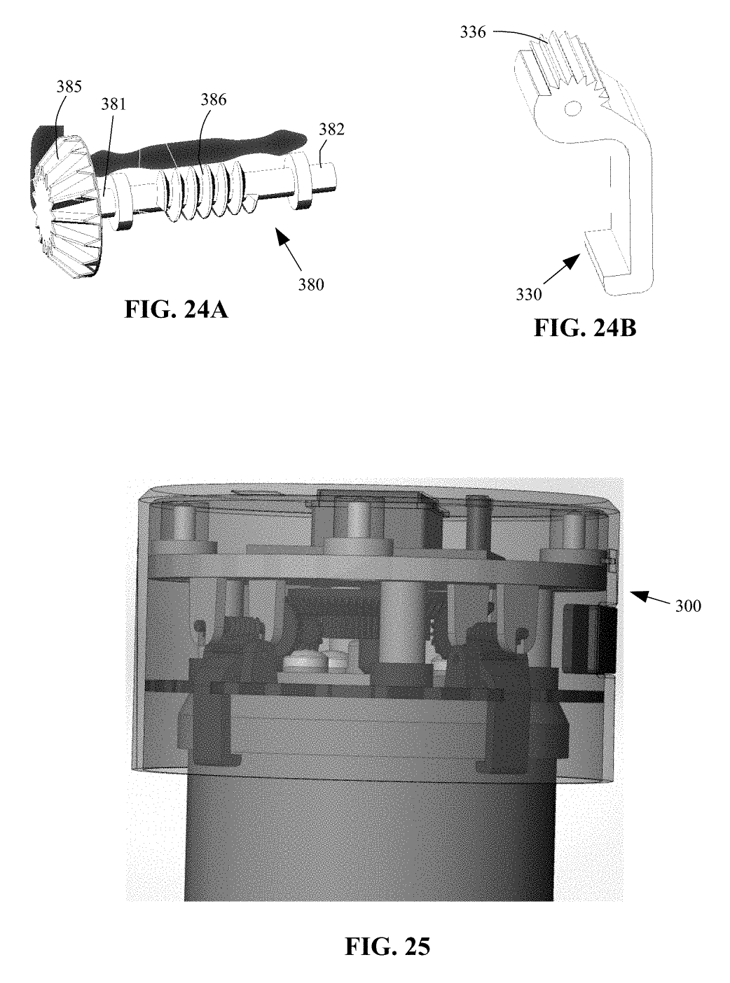

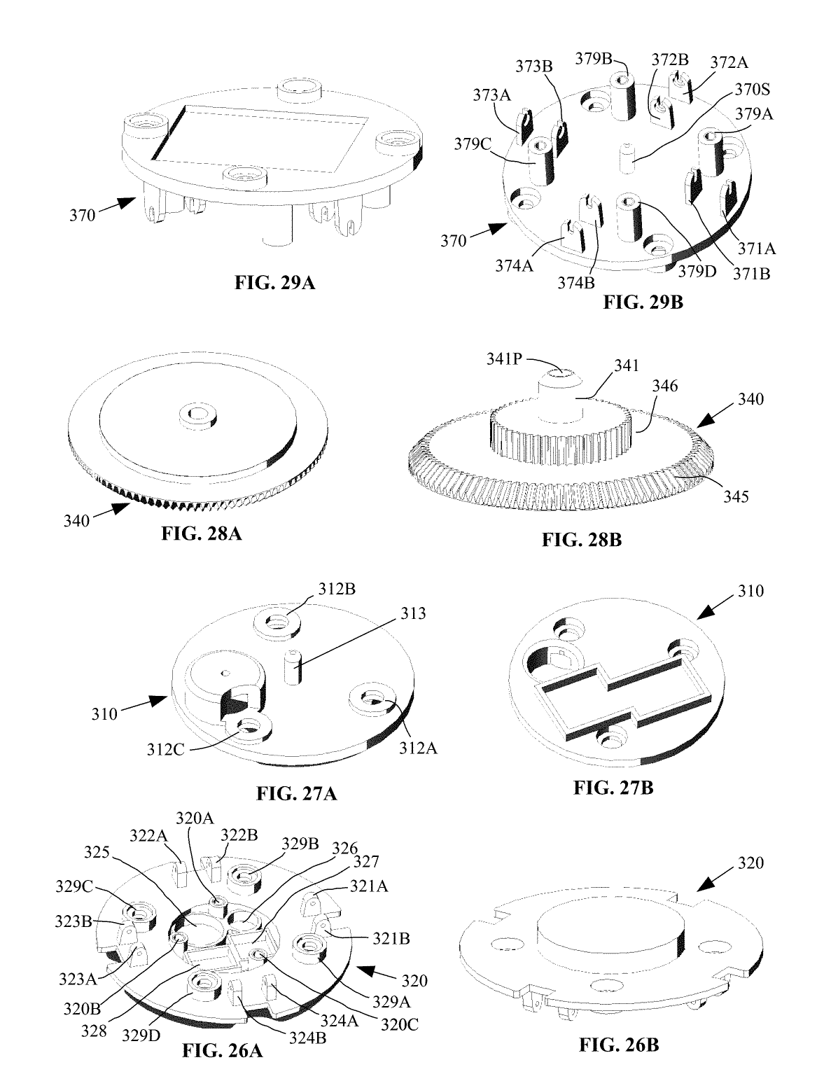

A cross-sectional view of a mechanical arrangement different than cap 200 is shown in FIG. 23 for cap 300. An exploded view of the parts used for cap 300 is shown in FIG. 24, and a perspective view of the assembled arrangement is shown in FIG. 25. The main component parts of cap 300 may be, a shroud 301, a digital display screen 309, a fingerprint reader 390, an upper housing 370 (shown enlarged in FIGS. 29A-29B), a drive member 340 (shown enlarged in FIGS. 28A-28B), a plurality of bevel gears 380 (shown enlarged in FIG. 249) which plurality may correspond to the number of clamp members utilized, a lower housing 310 (shown enlarged in FIGS. 27A-27B), an actuator 350, a battery 360, a Blue Tooth module 367, a microprocessor/computer chip 368, a bottle cover 320 (shown enlarged in FIGS. 26A-26B), and a plurality of clamps 330 (shown enlarged in FIG. 24B). Many of the component parts for cap 300 are the same or similar to those used for cap 200, and may be understood from the above description for cap 200 and from the accompanying figures. The description hereinafter is therefore focused on some of the principle differences, for which the reader may benefit from a discussion of the related features.

Cap 300 is shown to utilize two pairs of clamp members 330 (i.e., 4 clamp members, although other numbers of clamp member may be used). As may be seen in the cross-sectional view of FIG. 23, the clamp members are each pivotally mounted to the bottle cap 320, and may thus pivot between a clamped position with respect to the annular lip of the pill bottle, and an unclamped position. The bottle cap 320 (FIGS. 26A-26B) may have a clevis arrangement formed at four locations thereon (e.g., 321A/321B, 322A/322B, 323A/323B, and 324A/324B), to provide for pivotal mounting of the four clamp members 330 thereto. The actuator 350, battery 360, Blue Tooth module 367, and microprocessor/computer chip 368 may be respectively received within corresponding recesses 315, 316, 317, and 318 formed in the top side of bottle cap 320. The lower housing 310 may be positioned over those components to be secured to the bottle cover 320, using the three openings 312A, 312B, and 312C in the housing, and mechanical fasteners that may also be received in corresponding openings in the posts (e.g., 320A, 320B, 320C) formed on the bottle cover. The drive member 340 may be formed to create a compound gear arrangement, having a plurality of teeth 345 formed on a beveled outer periphery to create a bevel gear. The drive member 340 may also be formed with a central hub, upon which teeth 346 may protrude to form a spur gear. A shaft 341 may protrude from the hub, and may have a concentric through-hole 341P therein. The top side of upper housing 370 may be formed similar to housing 270 of cap 200. However, the bottom side of upper housing 370 may instead have a centrally positioned shaft 370S, onto which the drive member 340 may be pivotally mounted using the through hole 341P shown in the top surface of the drive member. The upper housing 370 may be mounted to the shroud 301 in substantially the same way as housing 270 is mounted to shroud 201 for cap 200. The bottom of the upper housing 370 may also have a clevis arrangement formed at multiple locations thereon (e.g., 371A/371B, 372A/372B, 373A/373B, and 374A/374B), to provide for pivotal mounting thereto of first and second shaft portions 381/382 of the corresponding plurality of bevel gears 380 (FIG. 24A), which may be mounted for the teeth 385 of those four gears to respectively engage and be driven by the teeth 345 of the bevel gear portion of the drive member 340. The bottle cap 320, with the other component parts assembled thereon as discussed above, may be secured to the posts 379A, 379B, 379C, and 379D of the upper housing 370, using mechanical fasteners received through the openings 329A, 329B, 329C, and 329D of the bottle cap. The posts 379A, 39B, 379C, and 379D may be formed with a height to suitably space apart the components, while maintaining as compact an arrangement as possible. However, as arranged, the mounting of the bottle cap 320 to the upper housing 370 may necessarily bring the gear teeth 336 formed on the top of the pivotal portion of each of the clamp members 330, into respective engagement with the helical gear teeth 386 of the bevel gears 380, as seen in FIG. 23. The drive member 340 may also be pivotally coupled to the shaft 313 of the lower housing 310 using the hole 341P in the shaft 341 of the drive member.

Operation of cap 300 may otherwise be generally similar to that of cap 200 and cap 100.

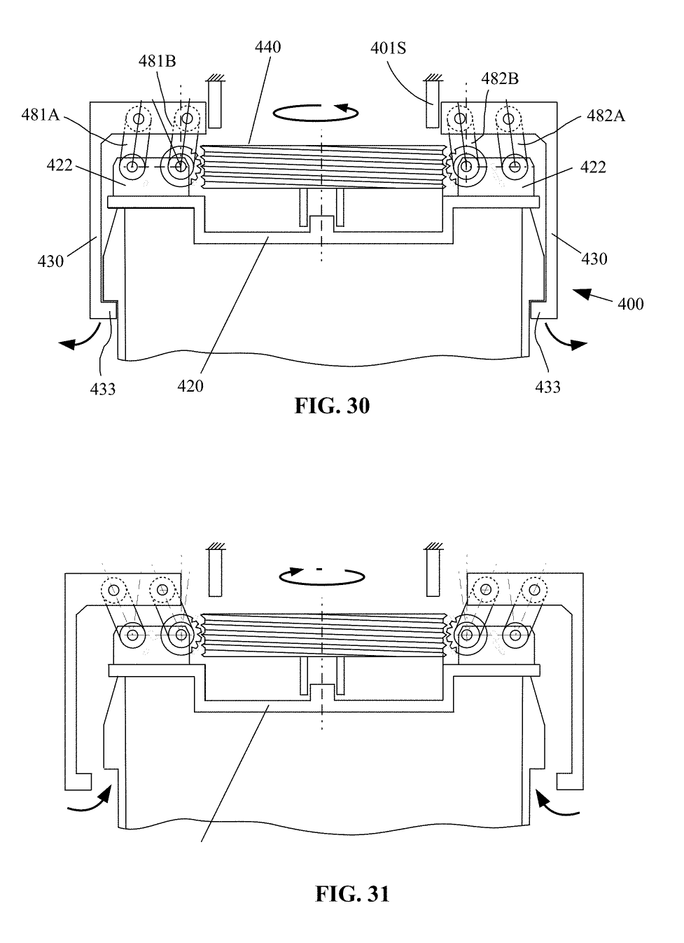

Another cap embodiment in shown in a schematic representation within FIGS. 30-31 for a cap 400, in which a plurality of clamp members 430 are each mounted to the bottle cover 420 using a mechanism. Unlike the other cap embodiments, the clamp members 430 used do not simply translate, or just rotate, and may instead undergo more complex curvilinear motion.

The clamp members 430 may each be supported by a pair of connecting links (e.g., 421A/421B, 422A/422B, etc.). A first end of each of the connecting links may be pivotally coupled to the clamp member, and a second end of each connecting link may be pivotally coupled to a flange (e.g., 421, 422, etc.) that may protrude up from the bottle cover 420. In one embodiment the connecting links may all be the same length, and the arrangement may be configured for each of the pairs of links to be pivotally coupled to the clamp member 430 to be parallel to each other, which may permit the short horizontal lower leg 433 of the clamp member to move such that it may retain its horizontal orientation regardless of its position. It should be noted that disparate lengths for the connecting links (e.g., 421A/421B, 422A/422B, etc.), and other mounting arrangements may be utilized to produce other movements of the lower leg 433 of the clamp members where it may not retain its orientation, in moving between the clamped and unclamped positions of FIGS. 30 and 31.

The lower pivotal coupling for the inner most connecting links (e.g., 481B, 482B, etc.) for each clamp member 430 may be formed with gear teeth on at least a portion of its periphery, or it may instead have a spur gear fixedly secured thereto, either of which may mate with teeth on the drive member 440. The drive member 440 may be driven by an actuator, the same as described hereinabove, for the drive member to thereby drive a connecting link of each clamp member 430, to impart motion to the clamp member. The connecting links (e.g., 421A/421B, 422A/422B, etc.) may also be configured to be oriented just past vertical (i.e., over-center) when in the clamped position, and the inner end of the clamp members may thereat butt against a stop (e.g., 401S) that may be formed in the shroud. Therefore, any attempt to force the short horizontal lower leg 433 of the clamp member downward may be resisted by the connecting link and its contact with the stop, rather than merely by the toothed engagement between its spur gear teeth and the teeth of the drive member 440.

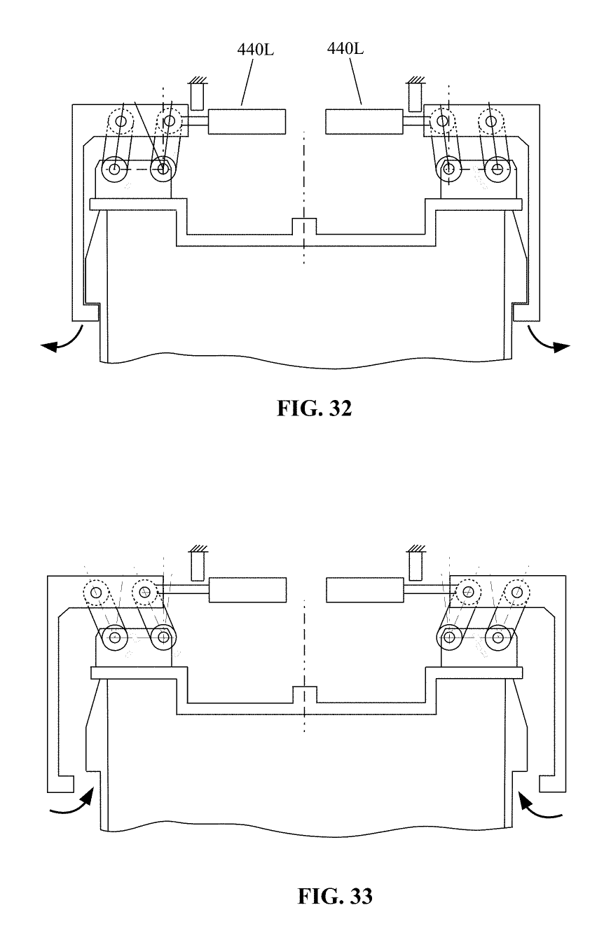

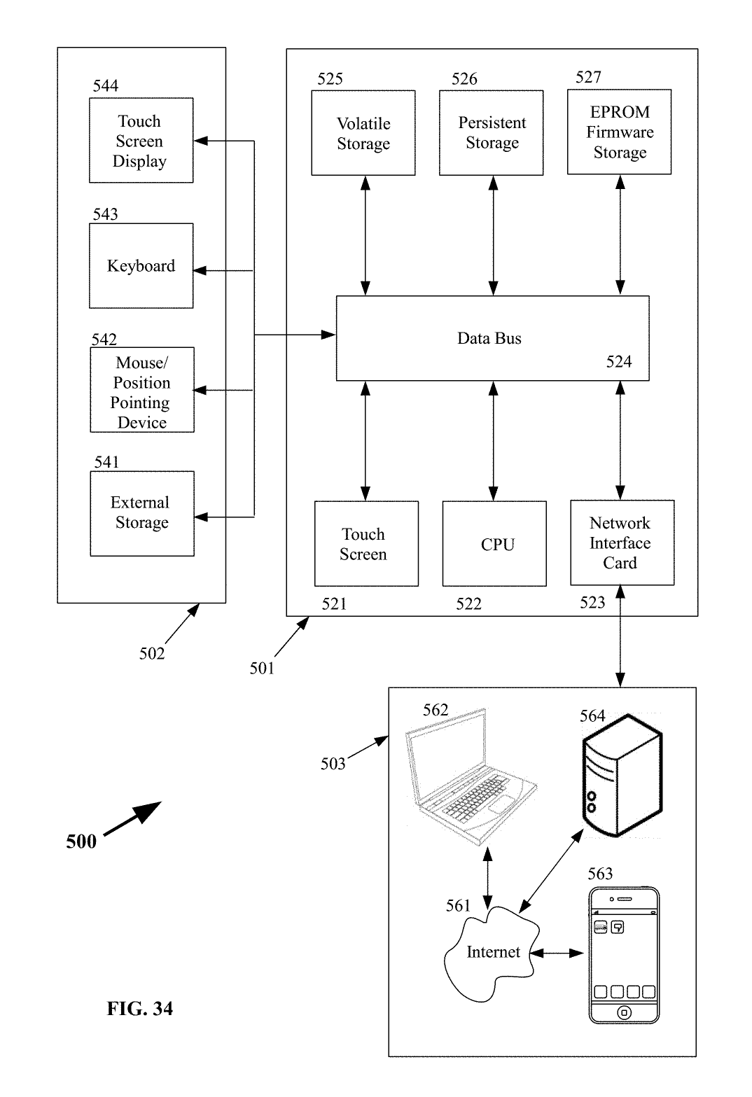

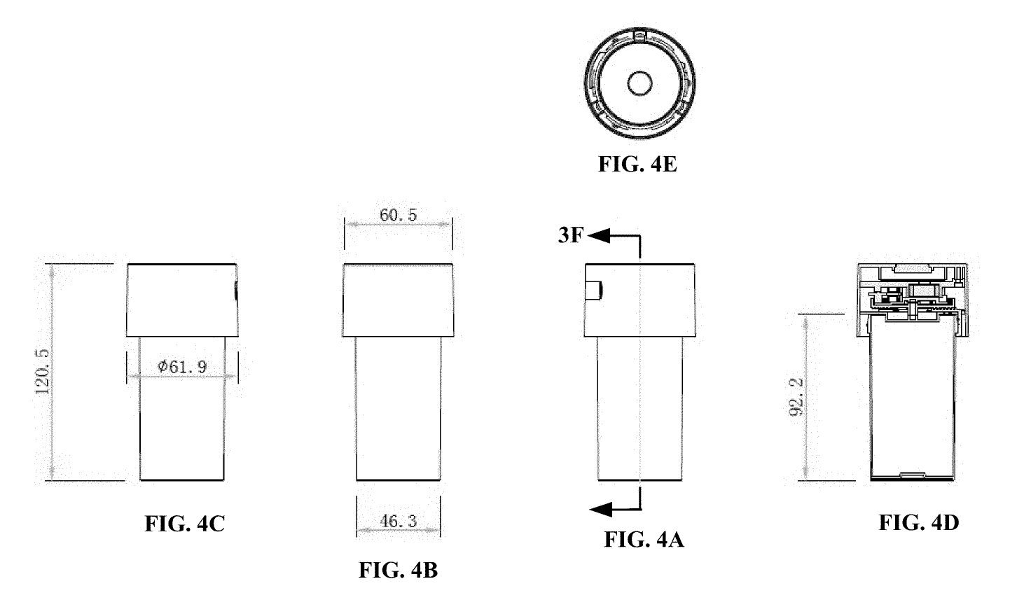

Note that as shown in FIGS. 32-33, a linear actuator 440L may be coupled to the connecting links and may be used to move the clamp members between the clamped and unclamped positions. It should therefore be realized that other actuator and clamp arrangements are also possible.

Software that may be utilized in conjunction with one or more of the pill cap embodiments described herein may run on a suitable computing device, such as a server, a tablet, a smart (cell) phone, or other mobile electronic device. Therefore, a description of such an exemplary computer system with peripheral devices is hereinafter disclosed, even though a particular embodiment may not require all or even any of the described components.

Exemplary computer system 500 (i.e., a client device associated with a particular user) is shown schematically in FIG. 21, and which may comprise computing unit 501 interacting with external peripherals 502, such as a separate touch screen display 544, and interacting with network resources 503, including use of the internet 561, and other computers (or other client devices or a server), which may be a laptop computer 562 (i.e., a second client device associated with a second user), a smart phone 563 (i.e., a third client device associated with a third user), a server 564, etc.

The computing unit 501 may include a data bus 524 for communicating information across and among various parts of computing unit 501, and a central processing unit, which may be a microprocessor (hereinafter “processor” or “CPU”) 522 coupled with a bus 524 for processing information and performing other computational and control tasks. Computing unit 501 may also include a volatile storage 525, such as a random access memory (RAM) or other dynamic storage device, coupled to bus 524 for storing various information as well as instructions to be executed by processor 522. The volatile storage 525 may also be used for storing temporary variables or other intermediate information during execution of instructions by processor 522. Computing unit 501 may further include a read only memory (ROM) or an erasable programmable memory (EPROM) 527 or other static storage device coupled to bus 524 for storing static information and instructions for processor 522, such as basic input-output system (BIOS), as well as various system configuration parameters. A persistent storage device or non-volatile memory 526, such as a magnetic disk, optical disk, or solid-state flash memory device may be provided and may be coupled to bus 524 for storing information and instructions.

Computing unit 501 may be coupled via bus 524 to an integral display 521, possibly a touch-screen display, for use in displaying information to a user and for interacting therewith. If desired, computing unit 501 may be coupled via bus 524 to an external display screen 544. An external input device 543 (e.g., a standard keyboard) may be coupled to bus 524 for communicating information and command selections to processor 522. A cursor control device 542, such as a mouse, a trackball, or cursor direction keys, may be used for communicating direction information and command selections to processor 522 and for controlling cursor movement on display 544. An external storage device 541 may be connected to the computing unit 501 via bus 524 to provide an extra or removable storage capacity for the computing unit 501, which may be used to facilitate exchange of data with other computer systems.

Some of the techniques herein may be performed by computing unit 501 in response to processor 522 executing one or more sequences of one or more instructions contained in the volatile memory 525. Execution of the sequences of instructions contained in a non-transitory memory may cause processor 522 to perform the process steps described herein. In alternative embodiments, specific hard-wired digital circuitry may be used in place of or in combination with, software instructions to implement the invention.

The term “computer-readable medium” as used herein refers to any medium that participates in providing instructions to processor 522 for execution. The computer-readable medium is just one example of a machine-readable medium, which may carry instructions for implementing any of the methods and/or techniques described herein. Various forms of computer readable media may contain one or more sequences of one or more instructions for the processor 522 to execute, including non-volatile media (storage device 526), and volatile media (storage device 525). Common forms of computer-readable media include, for example, a floppy disk, a hard disk, magnetic tape, or any other magnetic medium, a CD-ROM, a flash drive, and a memory card.

The computing unit 501 may thus also include a communication interface, such as network interface card 523 coupled to the data bus 522. Communication interface 523 may provide a two-way data communication coupling to a network link that may be connected to a local network. For example, communication interface 523 may be an integrated services digital network (ISDN) card or a modem to provide a data communication connection to a corresponding type of telephone line, or it may be a local area network interface card (LAN NIC) to provide a data communication connection to a compatible LAN.

Network link 523 also typically provides data communication to other network resources. For example, the network link may provide a connection over the internet 561 to the world-wide-web. Thus, the computing unit 501 can access resources located anywhere using the Internet 561. Also, the computing unit 501 may also be accessed by, or communicate with, other computers (e.g. 562), or another smart device (e.g., smartphone 563), generally with permission, and which may be located anywhere with access to the internet 561.

While illustrative implementations of one or more embodiments of the present invention are provided hereinabove, those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the exemplary embodiments without departing from the spirit of this invention.

Accordingly, the breadth and scope of the present disclosure should not be limited by any of the above-described example embodiments, but should be defined only in accordance with the following claims and their equivalents.

What is claimed is:

1. A method of securing a pill bottle comprising:
filling the pill bottle with a plurality of prescribed pills;
retrieving a pill bottle cap configured with: a shroud; a plurality of clamp members, each movably mounted to said shroud; a drive member interconnected with each of said clamp members and configured to cause the clamp members to move in a locking direction when said drive member is actuated in a first direction, and to cause said clamp members to move in an unlocking direction when said drive member is actuated in a second direction; an actuator configured to actuate said drive member to selectively move in each of said first and second directions; and biometric identification means coupled to said actuator, and configured to activate said actuator to cause said selective movement upon identification of an authorized use;
activating a read feature of the biometric identification means, and scanning of a fingerprint of an authorized user;
scanning of the fingerprint of the authorized user for moving the clamp members in the unlocking direction;
placing the pill bottle cap on the pill bottle; and
scanning of the fingerprint of the authorized user for moving the clamp members in the locking direction.

2. A pill bottle cap with biometric access control, said pill bottle cap comprising:
a shroud;
a plurality of clamp members, each movably mounted to said shroud;
a drive member interconnected with each of said clamp members to cause said clamp members to move in a first direction when said drive member is actuated in a first direction, and to cause said clamp members to move in a second direction when said drive member is actuated in a second direction;
an actuator configured to actuate said drive member to selectively move in each of said first and second directions; and
biometric identification means coupled to said actuator, and configured to activate said actuator to cause said selective movement upon identification of an authorized user.

3. The pill bottle cap according to claim 2 wherein said plurality of clamp members are equally spaced.

4. The pill bottle cap according to claim 2 wherein said actuator and said biometric identification means are each battery powered.

5. The pill bottle cap according to claim 2 wherein said shroud, said plurality of clamp members, said drive member, said actuator, and said biometric identification means are configured and positioned to minimize a height and a volume of said pill bottle cap.

6. The pill bottle cap according to claim 2 wherein said actuator is configured to actuate each said clamp member a discrete amount.

7. The pill bottle cap according to claim 2 wherein said actuator is configured to actuate each said clamp member to move a discrete amount by being actuated for a discrete amount of time.
